(19) United States
(12) Patent Application Publication
(10) Pub. No.: US 2017/0069031 A1
(43) Pub. Date: Mar. 9, 2017

(54) VARIABLE CALL-DATE BONDS

(71) Applicant: ENVIRONMENTAL FINANCIAL PRODUCTS, LLC, Chicago, IL (US)

(72) Inventor: Richard L. SANDOR, Chicago, IL (US)

(21) Appl. No.: 15/258,995

(22) Filed: Sep. 7, 2016

Related U.S. Application Data
(60) Provisional application No. 62/215,314, filed on Sep. 8, 2015.

(51) Int. Cl. G06Q 40/06; G06Q 20/10; G06Q 30/02

(52) U.S. Cl. CPC G06Q 40/06; G06Q 30/0239; G06Q 20/10

(57) ABSTRACT

A computer-based system, method and non-transitory medium for reducing cost to an issuer of a debt instrument. One or more computers and connected electronic storage that stores the computer-executable instructions, and data, together, process a structure for the operation of the debt investment which includes handling interactions with participants in the debt instrument and administrators by way of network connections. The computers establish payback terms for participants in the debt investment, including a standard payback scenario for most participants and an accelerated payback scenario for certain participants; establish identifiable certificates for portions of the debt; sell the identifiable certificates to the participants at an investment amount; select the certain participants for accelerated payback by randomly selecting certificates according to pre-established criteria; and arrange for the accelerated payback to the certain participants at one time and later payback for other participants at a later time.

This application claims the benefit of U.S. application 62/215,314 filed Sep. 8, 2015, the entire content of which is expressly incorporated herein by reference thereto.

### BACKGROUND

Generally, corporations, municipalities, government agencies, investment trusts, and governments at all levels of sovereignty and jurisdiction issue debt obligations in the form of interest-bearing bonds that have a stated principal amount, maturity date, and schedule of interest payments and principal repayments. Interest is paid at regular intervals to the bondholder, generally semi-annually or annually, based on the principal amount of the bond and the stated interest payment rate. The bond's interest payment rate is also known as the coupon rate of interest. Bonds issued in bearer form have coupons attached to the bond certificate, which are physically detachable. On or after an interest payment date, the bondholder detaches the particular coupon and presents it to the paying agent for payment. A bondholder who chooses to do so can detach coupons from a bearer certificate and sell them separately. In contrast, a bond issued in registered form does not have detachable coupons, but is registered in the name of the owner, who receives regular payments of interest from the issuer or his agent.

The principal amount of the bond is repaid to the bondholder on one or more dates that are specified at the time of issue with the final installment payable on the bond's maturity date, which is commonly between one to as long as forty years after the issue date of the bond. Often, when a borrower issues a bond it retains the option to call the bond for redemption before its scheduled maturity date. This option allows the borrower to terminate its continuing obligation to pay interest at the stated rate if market interest rates drop significantly below the stated interest rate after the call option becomes effective. The dates and prices at which a bond can be called are established when the bond is issued, and published in a schedule of call prices. This call option gives the issuer flexibility in managing and refinancing its outstanding debt.

The yield at which investors are willing to invest money varies over time depending on existing economic conditions and also on conditions forecasted for the future. The yield also varies depending on the length of time for which the investor commits his money, with longer term debt generally bearing higher yields than short term debt.

The interest rate to be paid by the bond issuer is of course subject to market conditions. Corporate bonds are issued at one interest rate while municipalities typically offer a lower interest rate because their return on investment is free of federal and state taxes. Despite this advantage for municipal bonds, the interest rates on the large amounts that need to be raise for the municipalities are not insignificant and represent a cost to the municipality.

The above bond issuance methods and the associated rules have been implemented in computer systems. Such implementation is necessary because a large amount of funds need to be raised (e.g., $1 Million, $10 Million, or more), the funds are raised through numerous individuals or bonds (e.g., 1000, 5000, or more individuals or bonds), the entity raising the funds is remote from the individuals, and the funds need to be raised quickly and accurately. The associated rules, such as principle and interest amounts to be paid to the bondholders, the frequency and dates of principle and interest payments, the maturity date based on the amounts and frequency of principle and interest payments, and the option to call the bond for redemption before its scheduled maturity date, may be easy to determine by human for one or a few individuals, but it becomes impossible when there are hundreds or thousands or even for tens of bondholders, as these determinations require accurate and speedy calculations on a consistent and uniform basis. The existing computer systems for bond issuance, however, fail to reduce the costs of borrowing the funds necessary to carry out their planned activities, fail to incentivize potential bondholders or current bondholders to purchase debt instruments or additional debt instruments, fail to consider market conditions in order to sell debt instruments in a competitive financial market without prejudice, fail to take into account the mentality of bondholders to determine and provide different levels of interest rates and repayment options, and fail to maximize the returns the bondholders will receive. These issues have been recently experienced after years of studies and research and are not yet known to the bond industry.

Thus, there is a need for improved computer systems and computer-implemented methods that solve the deficiencies mentioned previously. The computer systems and the computer-implemented methods of the present invention are the pioneers in addressing these previously unknown issues.

### SUMMARY OF THE INVENTION

The invention relates to a computer-based system for reducing cost to an issuer of a debt instrument, comprising one or more computers and connected electronic storage that stores computer-executable instructions and data that is used by the computer-executable instructions, wherein the one or more computers, the computer-executable instructions, and data, together, configure the computer system to process a structure for the operation of the debt investment which includes handling interactions with participants in the debt instrument and administrators by way of network connections. The one or more computers are configured to establish payback terms for participants in the debt investment, including a standard payback scenario for most participants and an accelerated payback scenario for certain participants; establish identifiable certificates evidencing portions of debt of the debt instrument; sell the identifiable certificates to the participants at an investment amount; select the certain participants for accelerated payback by randomly selecting some of the certificates according to pre-established criteria that at least include an earlier time of payment; and arrange for payback of the investment amount for the certain participants at one time and for other participants at a later time.

The selected certain participants typically receive a higher payback compared to other participants who receive payback at a later time. Also, the one or more computers are further configured to raise funds from all the participants purchasing the debt instruments at a particular cost which is usually below market interest rate.

The accelerated payback scenario generally comprises a plurality of call events each of which selects the certain participants for the accelerated payback. Preferably, each of the call events arranges for payback of the investment amount for the certain participants and each payback amount is higher than payback amount received by other participants at a time after all the call events end. Alternatively, each of the call events arranges for payback of the investment amount for the certain participants and the participants selected in an earlier event receives a higher payback compared to the participants selected in a later event. For these scenarios, the number of selected participants in each event would typically be the same.

The payback of the investment amount for the certain participants and for the other participants may include coupon payments. These coupon payments are paid to participants in the standard payback scenario and in the accelerated payback scenario until participants are selected or until debt instrument mature. The accelerated payback scenario comprises a plurality of call events each of which selects the certain participants for accelerated payback. Also, the coupon payments are paid to participants in the standard payback scenario and in the accelerated payback scenario in each call event until participants are selected or until debt instrument mature. Again, the number of selected participants in each event is typically the same.

In another embodiment, the one or more computers are further configured to raise funds from all the participants purchasing the identifiable certificates at a particular cost, which includes the investment payback to participants. The particular cost may be below market interest rate.

Another embodiment of the invention relates to a computer-based method for reducing cost to an issuer of a debt instrument, wherein all steps are conducted by a computer system. The method comprises the steps of establishing payback terms for participants in the debt investment, including a standard payback scenario for most participants and an accelerated payback scenario for certain participants; establishing identifiable certificates evidencing portions of debt of the debt instrument; selling the identifiable certificates to the participants at an investment amount; selecting the certain participants for accelerated payback by randomly selecting some of the certificates according to pre-established criteria that at least include an earlier time of payment; and arranging for payback of the investment amount for the certain participants at one time and for other participants at a later time.

In addition to the computer processing described above, the method includes configuring the one or more computers to provide the selected certain participants with a higher payback amount compared to other participants who receive payback amounts at a later time. Preferably, the one or more computers are further configured to raise funds from all the participants purchasing the debt instruments at a particular cost that is below market interest rate.

The accelerated payback scenario may comprise a plurality of call events each of which selects the certain participants for the accelerated payback, and wherein the one or more computers are further configured to arrange for paybacks to the certain participants at each call event and to the other participants at a time after all the call events end. Alternatively, each of the call events arranges for payback of higher amounts to certain participants selected in an earlier event compared to other participants or to participants selected in a later event, and wherein the number of selected participants in each event is the same.

The method also provides for the payback amounts for both the selected certain participants and for the other participants to include coupon payments, wherein the coupon payments are paid to all participants until debt instrument matures or at least until the certain participants are selected.

The invention also relates to a non-transient computer-readable medium encoded with a computer program, the computer program comprising instructions that when executed by a computer system cause the computer system to perform the methods described herein.

The computer-based systems and computer-implemented methods of the present invention also present a novel design and structure for the present financial instruments which are termed Variable Call-Date Bonds (VCBs). The new financial instrument differs from existing bond design methodologies in that the returns are a function of both coupon rate and additional return when bond are called on specified call dates. In particular, the VCBs are governed by parameters and other criteria such as the offering amount, face value at maturity, length of bond maturity, yield percentage, coupon rate, coupon frequency, call event frequency, number of calls at each event, call percentage, price of bond instrument, and total number of bonds. The issuer is able to borrow the fund at a lower than market rate (which is about 3% for conventional bond instruments) while maintaining sufficient investor interest in the VBCs. This establishes the fund at a lower than market rate and allows certain VCBs to be called prior to the maturity date which unexpectedly provides additional profit to the investor compared to conventional bonds. The innovative structure of these VCBs allows the issuer to borrow at minimum or zero coupon payments while providing sufficient incentive for bond purchases (investors) in the event that from the bond is called earlier than the maturity date.

### DETAILED DESCRIPTION OF THE INVENTION

The proposed computer-based systems and computer-implemented methods present a novel design for financial instruments for bonds using VCBs. The proposed systems and methods combine elements of a conventional bond instrument design with variable date callable structure to create a new fixed income instrument. This approach differs from existing bond design methodologies in that the returns are a function of both coupon rate and additional return when bond are called on specified call dates. The innovative structure of these VCBs allows the issuer to borrow at minimum or zero coupon payments. The structure provides sufficient incentive for bond purchases (investors) due to the significant upside from a bond being called earlier to maturity. The proposed structure can be especially useful for public sector, States and municipalities but can also be used by any entity that is issuing a bond or similar debt instrument that requires periodic payments or a future payback.

In one embodiment, the computer system may create a VCB instrument as a zero coupon bond or a conventional bond with fixed coupons. Zero coupon bonds, otherwise called accrual bonds, are designed with zero or very little coupon payment and sold at considerable discount to par value. These instruments provide par value at maturity. The computer system may create a VCB instrument with the corresponding characteristics in response to user selection on the computer system.

Once created, the computer system may issue a fixed number of such VCBs to the market place or a plurality of computer systems configured to receive some of the VCBs. The number of VCBs to be issued may be determined automatically by the issuing computer system or manually by the user of the issuing computer system through the issuing computer system. Each of the issued VCB instruments has a unique identifier assigned by the issuing computer system. The receiving computer system may be further configured to purchase the received VCBs. Purchase can be made automatically by the receiving computer system or manually by the user of the receiving computer system through the receiving computer system. The financial proceeds from the VCB instruments sales are transmitted to the issuing computer system or a computer system designated to receive the financial proceeds. The financial proceeds may be used for any purpose by the issuer. The issuer may also set up a sinking fund. Issuer refers to individual, entity, or government that issues the financial instruments. Purchaser refers to individual, entity, or government that purchases financial instruments. Purchaser may also refer to instrument holder, bond holder, VCB holder, or investor.

The issuing computer system may be configured to generate a draw or call event in which a pre-determined percentage (or call percentage) of the issued VCBs are called prior to maturity. The issuer may specify the call percentage and call events schedule in the issuing computer system. The call percentage refers to the percentage of issued bonds that are called in each call event. Issuers may also specify a fixed or variable call percentage schedule in the issuing computer system.

Based on the call percentage, the issuing computer system randomly selects or calls a number of issued VCBs in a call event and those randomly selected or called VCBs are eligible to be paid at face value. The unique identifiers on the selected VCBs are used to determine which purchased VCBs are eligible to be paid at face value. The face value then may be paid by the issuing computer system to the corresponding purchaser, its receiving computer system, or a computer system designated by the purchaser to receive the profit. Hence, VCB holders who are called earlier get a higher return on their investment than VCB holders are called at a later time.

The VCBs that are not called by the issuing computer system are held by the issuing computer system until the next call event in which another set of bonds are randomly called again and are eligible to redeem at face value. The process continues according to the call events schedule. After the last call event, the issuing computer system stops the calling process. Bonds that are uncalled after the last call event continues until expiration when they can be redeemed at face value or be paid as described above.

The process is described herein in Table 1.

TABLE 1
One Preferred Embodiment of The Present Invention

| | |
|---|---|
| Step 1: | 1. Providing a computer system configured with VCB. |
| Bond | 2. Inputting and/or changing VCB parameters (e.g., with |
| Issuance | or without coupon, coupon rate, call percentage, call |
| | events schedule, etc.) presented by the computer system |
| | by an issuer (e.g., government or private agency). |
| | 3. Issuing VCBs with information detailing the |
| | number of total issuances, whether the |
| | issuances are with or without coupon, call |
| | percentage, call events schedule, etc. by the |
| | computer system to a plurality of computer systems |
| | configured to receive and/or purchase a |
| | portion of the total issuances. |
| Step 2 | 1. Randomly calling or selecting a pre-determined |
| Call event | percentage of issued VCBs in a call event at |
| Process | a time defined by the call events schedule. |
| | 2. Allowing holders of the called VCBs to redeem |
| | the face value of the VCBs. |
| | 3. Repeating the calling process and the redemption |
| | process for each call event in the call events schedule |
| | through the maturity of the issued VCBs. |
| Step 3 | 1. Redeeming uncalled VCBs after conclusion of the |
| Bond | call events schedule at face value on the maturity date. |
| Redemption | |

The present invention is executed by modern computing technology. The computer technology is user-interactive and may be self-contained so that users need not leave or venture to another address within a distributed computing network to access various information. The following discussion describes the structure of such an environment, such as the Internet or many common intranets.

The computing environment includes one or more servers which communicate with a distributed computer network via communication channels, whether wired or wireless, as is well-known to those of ordinary skill in the pertinent art. The server hosts multiple Web sites and houses multiple databases necessary for the proper operation of the subject technology.

The server is any of a number of servers known to those skilled in the art that are intended to be operably connected to a network so as to operably link to a plurality of client computers via the distributed computer network. The plurality of client computers can be desktop computers, laptop computers, personal digital assistants, cellular telephones, and the like. The clients allow users to access information and run applications on the server and locally. The server and clients have displays, input devices, and output devices as would be appreciated by those of ordinary skill in the pertinent art. The server may be referred to as the issuing computer system and the client may be referred to as the receiving computer system.

In particular, in the present invention, the computing environment is structured to carry out the foregoing functionalities and provide related interacted features and tools. The server, the client computer, or a combination thereof can be directed towards managing the bond or debt fund or investment (“debt investment”), selecting participants for early payout, and for coordinating and conducting repayments according to the schedules proposed. Each of these computers is connected to electronic storage (e.g., transient or non-transient memory) that stores computer-executable instructions and data that is executed by a processor of these computers. These computers, along with their processors, electronic storage, computer-executable instructions, and data, configure the computer environment to provide an interactive application that processes a structure for the operation of the bond fund or investment which includes handling interactions with potential participants, participants, and administrators by way of network connections with client end devices.

The interactive application may also be referred to as an Overlay System (OS) or implemented by the OS. Each computer in the computing environment is also configured to register participants in the debt investment, and receive and store account information about the participants. The computer is further configured to create individual accounts for participants in the debt investment, wherein accounts are available to be created for determining, paying and recording payments according to the payment schedule and advanced call date for a liquidation phase of their account. The OS may also provide the account creation interface.

Each computer in the computing environment is also configured to receive and store principal data identifying one or more amounts contributed by each participant into the debt investment and generate and store ownership data that identifies the ownership stake. Preferably, the server is further configured to implement the structure governing the selection timing and operation of the fund repayment for each participant in the debt investment by a specified formula. The server is also configured to select those investors that are to receive the early payout according to one or more of various section scenarios.

The selection can be conducted in a variety of ways. Each participant would receive a numbered certificate, in denominations of the same amount (e.g., $1000). The selection of the participants for early call could be determined by a random number generator in the server which selects some of those numbered certificate for early payout. The server can also use other random selection criteria for this purpose.

According to one embodiment, the server calculates the advance payouts by determining an early payout to a preselected number of participants in the debt instrument. Alternatively, the server can calculate the number of participants to achieve a payout that results in a preselected final interest rate to the issuing entity. For example, if the going interest rate is 5% and the issuing entity offer the debt instrument at a rate of 4% but wishes to not exceed 4.35% due to the early calls, the server can calculate the number of certificates that can be selected to meet that overall number. The server can calculate these prior to issuance of the debt instrument and the rules and conditions for the debt instrument can include the details of what proportion of certificates will be called early and at what time.

And as a skilled artisan would understand, the present invention may be used with zero coupon bonds or with coupon bearing bonds that include a provision that an early payout would be at an increased interest rate compared to payouts by holding the instrument until maturity. For example, a bond that has a 4% coupon each year can agree to pay a higher interest rate if called earlier. For a 30 year municipal bond, for example, the early call can be a payment of 10% for a selected number of certificates each year for the first 5 years, and lower interest rates for other certificates over a further period, etc. Again, the server can calculate and determine the payout schedule and number of early calls depending upon the final total interest rate that the issuer wishes to achieve.

The server is further configured to generate output data that specifies a calculated current value of a participant's certificates. The server is also configured to implement an account value interface through which the client computers may interact with the server to receive and provide information about the current value to fund participants and the projected payout date. The OS may also provide the account value interface. The server is also configured to issue scheduled payments from the debt investment by date according to the rules and requirements governing the terms of the investment.

In one embodiment, the computing environment or the server may further comprise a fund completion or termination component that is configured to determine, as an ongoing process, which fund participants have been repaid and which are still eligible for payment or repayment, thus including an identification of the participants remaining in the investment or fund, as well as when the fund is closed or completed.

The client computer may be further configured to include an administrative interface that provides interactive options that allow fund providers to configure working characteristics of the fund that instruct the server to perform operations according those characteristics. In another embodiment, the administrative interface or the client computer is also configured to be implemented as an overlay system. The server may be further configured to include a sales system that provides models of the operation of the investment fund incorporating a demographic return fund. The client computer may access that system through the distributed network.

In another embodiment, the server may account for administrative expenses or fees for managing the debt investment to be periodically withdrawn. The server typically includes an interface for interactivity with financial advisors or other intermediaries for this purpose.

In yet another embodiment, the server also comprises a component that permits participants to login to view the status and value of their certificates from a website, client application, or client computer.

The computing environment can be directed towards implementing an interactive platform on a server that permits the creation of the debt investment including interfaces for participants, administrators, and fund managers to interact with the fund to view the value of the investment, the periods of time or schedules for payments. The administrators and fund managers may interact with the fund by using the server since they have direct control of the server. The participants may interact with the fund through their respective client applications or client computers.

Each computer system may further comprise input devices such as a keyboard, pointing device (e.g., mouse, trackball, or touch pad), microphone, joystick, satellite dish, scanner, and the like. The user of each computer system may interact with his or her respective computer by using these devices. The user of each computer system may enter commands and information into his or her respective computer system through these devices and the computer system may operate based on the entered commands and information. The results of the operation may be displayed on a monitor of the computer system. The commands and information that may be entered into and the results that may be displayed by a computer system (e.g., issuing computer system) may be different from those of another computer system (e.g., receiving computer system) as they are configured to provide different functions in the computing environment or have different roles in the computing environment. Each computer system may have an associated graphical user interface (GUI) allowing such input and display. The input devices may be connected to the processor through a user input interface such as a parallel port, universal serial bus (USB), or other similar interface. Each computer system may comprise other output devices such as speakers and printer, in addition the monitor, and they may be connected to the processor or the computer system through the same user input interface. The output devices may also be connected to a different interface, such as a output peripheral interface which may be high-definition multimedia interface (HDMI), digital visual interface (DVI), video graphics array (VGA), or the like.

A computer-readable storage medium such as a non-transitory computer readable medium can comprise instructions executed by a processor or electronic device to perform at least some and preferably all of the steps of the methods and systems described herein.

### EXAMPLES

Embodiments of the present invention will now be illustrated by the following examples:

### Example 1

### Zero Coupon Bonds

A municipality (the issuer) is interested in raising $10 Million thorough a municipal bond issuance for some developmental projects. One of the issuer's computer systems may be configured with VCB function and this computer system may be referred to as the issuing computer system or the server. After the configuration, the server may display through its monitor an interface such as an GUI with VCB parameters and other criteria that determine how the fund will be raised. These VCB parameters and other criteria may be input or adjusted by the issuer through the input devices. These VCB parameters and other criteria may include but not limited to the offering amount, face value at maturity, length of bond maturity, yield percentage, coupon rate, coupon frequency, call event frequency, number of calls at each event, call percentage, price of bond instrument, and total number of bonds. Through the server and these parameters and criteria, the issuer can borrow the fund at a lower than market rate (which is about 3% for conventional bond instruments) while still maintaining sufficient investor interest. The parameters and criteria, along with the VCB module that operates based on these parameters and criteria, set up the server to raise the fund at a lower than market rate and to provide bonds called prior to the maturity date to earn extra profit, which are some improvements over the existing bond issuance computer systems. Module refers to software that is executable by the processor of the server. Current bond issuance computer systems are not designed to help reduce costs associated with fund raising. Even if they do somehow, those systems and methods are generally not attractive to investors and/or do not reduce the costs significantly. Current bond issuance computer systems also do not incentivize investors when the interest rate is low. Even if they do somehow, those systems and methods do not allow some of the bonds to be redeemed early and to receive additional earnings. For example, when the issuer wants to raise fund through zero coupon call bond instrument, the server may display VCB parameters and criteria on its associated GUI and the issuer may input information in the corresponding parameters and criteria into the server as shown below:
Offering Amount: $10,000,000 (10 Million USD)
Face Value At Maturity: $1000
Bond Maturity: 5 year
Yield: 2%
Coupon Rate: 0%
Coupon Frequency: Not applicable
Call Event Schedule: Annual
Number Of Call Events: 3
Percentage Bonds Eliminated In Each Call Event: 5%
Price Of Bond Instrument: $905.732
Total Number Of Bonds CUSIPS: 10,000

Some of the parameters and criteria may also be automatically determined by the server. The VCBs may be serially labelled with CUSIPS numbers which may serve as unique identifiers. Details of the bond offering is presented in table below. The bonds are priced using traditional bond pricing formula, such as the shown in http://www.zenwealth.com/businessfinanceonline/BV/BondCalculator.html, which is also integrated with the server or built into the VCB module. Moreover, the total number of bonds issued will equal to the fund to be raised divided by the bond price. In response to the issuer input parameters (and the server-determined parameters if there are any), the server may compute and display the following information as shown in Table 2. The information may include the number of call events, the number of issues uncalled by each event, the number of issues called by each event, and the return percentage for the issues called by the event.

TABLE 2
Schedule of VCB Investor Returns From Variable-Date Calls

| Call Events | Issues Uncalled | Issues Called | Redemption Return |
|---|---|---|---|
| 0 | 10,000 | 0 | 0 |
| 1 | 9,500 | 500 | 10.41% |
| 2 | 9,000 | 500 | 5.08% |
| 3 | 8,500 | 500 | 3.36% |
| 4 | 8,500 | 0 | N/A |
| 5 | 0 | 8,500 | 2.00% |
| | | 10,000 | |

In the above example, a VCB with a face value $1000, 5 year term and 2% required return is priced at $905.73. The issuer is therefore able to raise $9,057,300,000 and will be required to pay $10 million at the maturity of the bonds through the server. Further, the VCB in the server is configured to include 3 call events per year for 5 years where 5% of the issued bonds are randomly drawn by the server and are eligible for immediate redemption at face value. Per these rules, 500 bonds (i.e. 5% of 10,000) are called by the server for redemption in each call event. At the end of 5 years, the remaining uncalled VCBs mature and the remaining VCB holders may redeem their bonds from the server through their respective client applications or client computers. The column labelled with Redemption Return represents the rate of return for the investors of the issues called in each call event. The server may transmit the payments to the receiving computer system that has the bonds that were called. The server may also instruct another computer system that is configured to make and transmit such payments and the receiving computer system may also designate another computer system to receive such payments.

While all the information associated with all 5 called events are displayed, the server may compute and display the information for each event as the bonds are called. For example, when there is only one call event occurred thus far, only the information associated with that call event may be computed and displayed. As shown in the table, VCB holders who are called earlier make a higher return on their investment than those who are called later. Such a feature is missing from and is an improvement over conventional bond issuance computer systems and computer-implemented methods.

### Example 2

### Coupon Bonds

The municipality in Example 1 now decides to use an alternate, more traditional coupon bond structure along with a VCB component to raise the same amount of fund. The VCB parameters and other criteria are input or adjusted by the issuer. Some of the parameters and criteria may be automatically determined by the server. Since the fund is raised through coupon bonds, the coupon rate is greater than zero and the coupon frequency indicates how often the investors may redeem each coupon for return. The issued VCBs may be serially labelled. For example, the server may be configured with the following parameters and criteria and compute and display the information as shown in Table 3 in response to those parameters and criteria.
Total Bond Offering: $10,000,000 (10 Million USD)
Face Value At Maturity: $1000
Bond Maturity: 5 year
Expected Return: 2.00%
Coupon Rate: 0.5%
Coupon Frequency: Annual
Call Event Schedule: Annual
Number Of Call Events: 3
Percentage Bonds Eliminated In Each Call Event: 5%
Price Of Bond Instrument: $929.344
Total Number Of Bonds CUSIPS: 10,000

TABLE 3
Schedule of VCB Investor Returns From Variable-Date Calls

| Call | Issues | Issues | Cumulative | Redemption |
|---|---|---|---|---|
| Events | Uncalled | Called | Coupon Payment | Return |
| 0 | 10,000 | 0 | 5 | 0 |
| 1 | 9,500 | 500 | 10 | 8.51% |
| 2 | 9,000 | 500 | 15 | 4.25% |
| 3 | 8,500 | 500 | 20 | 2.98% |
| 4 | 8,500 | 0 | 25 | N/A |
| 5 | 0 | 8,500 | | 2.00% |
| | | 10,000 | | |

In the above example, a VCB with a face value $1000, 5 year term and 2% required return is priced at $929.34. In this case, the issuer is able to raise $9,293,400,000 and will be required to pay $10 million at maturity of the bonds through the server. Similar to Example 1, the VCB mechanism or module in the server is configured to include 3 call events per year for 5 years where 5% of the issued bonds are randomly drawn by the server and are eligible for immediate redemption at face value. Per these rules, 500 bonds (i.e. 5% of 10,000) are called by the server for redemption in each call event.

At the end of 5 years, the remaining uncalled VCBs mature and the remaining VCB holders may redeem their bonds from the server through their respective client applications or client computers. The payments are made, transmitted, and received in the manners described above. While all the information associated with all 5 called events are displayed, the server may compute and display the information for each event as the bonds are called. For example, when there is only one call event occurred thus far, only the information associated with that call event may be computed and displayed.

One important difference from the previous example is that the bond holder receives the coupon payment of $5 (0.5% of 1000) each year as long as his or her bonds are not called by the server. The total return for a called bond is therefore its coupon payment from the time the bonds are issued until the time the bonds are called and the return from the early call. The cumulative coupon payment is presented in the table above and represents additional return from the coupon payment.

The column labeled Redemption Return presents the rate of return for the investors of the issues called in each call event which include the accrued coupon payments in addition to the return from the early call. As shown in the table, VCB holders who are called earlier, make a higher return on their investment than those who are called later. Such feature (e.g., the combination of accrued coupon payments and higher return for early called bonds) is missing from and is improvement over conventional bond issuance computer systems and computer- implemented methods.

The above example illustrates how the inclusion of a variable date-call component into a computer system or computer-implemented method with a traditional bond design can result in a preferred outcome for the issuer and the risk-taking investor.

In both examples, from the issuer's standpoint, the issuer was able to raise the funds at a less than market borrowing rate. In the case of the zero coupon bonds, the issuer raised $10 million at an average cost of 2.65% of the raised amount when the prevailing market borrowing cost was 3.00%. The average cost of 2.65% is arrived at as the average weighted rate of borrowing due to the additional cost incurred to pay off the early called bonds. In spite of this additional cost, the issuer was able to borrow at 35 bps less than the market rate. In the case of the coupon bonds, the issuer was able to raise the $10 million at a slightly lower rate of 2.45%. Clearly, both structures allowed the issuer to be better off.

From the investor's standpoint, the investors in the zero coupon bond situation made an average of 2.65% (and 2.45% return in the zero coupon situation) which is 35 basis points (which is 22.5bps) less than the market rate. The anticipation of being called early motivates investors to participate in either type of investment as being called early provides a higher redemption rate.

In the case of the zero coupon bonds, the 1500 bond holders (i.e. 500 from call event 1+500 from call event 2+500 from call event 3) who were lucky to be called earlier made at least 3.36% in return, with those being called in the first year making 10.41% in return and those being called in the second year making 5.08% in return. These high return rates offered by the present invention reflect a significant upside compared to the prevailing market rate. Those who are not called after all the events received a base return of 2% at maturity.

In the case of the coupon bonds, the 1500 bond holders who were called earlier received return from early call as well as coupon payments for the length they own the bonds. Hence, those who were called later were compensated from accrued coupon payment. The returns ranged from 8.51% to 2.98% depending on when they were called.

In both examples, the opportunities to be called earlier and their associated benefits motivate the risk-taking individuals to purchase bonds with a VCB mechanism.

The above mechanism can be used to create structured bond instruments benefiting both the borrower and the lender. It is of particular interest to government agencies, municipalities and states where funds can be raised with lower need to raise taxes or dipping into to other scarce funds to meet borrowing costs.

It will be understood by those of ordinary skill in the art after reading the disclosure and as expressed herein that if desired, one or more features of elements of the exemplary system, method, or computer readable medium can be removed, modified, or re-arranged to arrive at a broader or different version of the system, method, or computer readable medium without departing from the spirit and scope of the invention.

What is claimed is:

1. A computer-based system for reducing cost to an issuer of a debt instrument, comprising:
one or more computers and connected electronic storage that stores computer-executable instructions and data that is used by the computer-executable instructions, wherein the one or more computers, the computer-executable instructions, and data, together, configure the computer system to process a structure for the operation of the debt investment which includes handling interactions with participants in the debt instrument and administrators by way of network connections;
with the one or more computers configured to:
establish payback terms for participants in the debt investment, including a standard payback scenario for most participants and an accelerated payback scenario for certain participants;
establish identifiable certificates evidencing portions of debt of the debt instrument;
sell the identifiable certificates to the participants at an investment amount;
select the certain participants for accelerated payback by randomly selecting some of the certificates according to pre-established criteria that at least include an earlier time of payment; and
arranging for payback of the investment amount for the selected certain participants at one time and for other participants at a later time.

2. The system according to claim 1, wherein the one or more computers are configured to provide the selected certain participants with a higher payback amount compared to other participants who receive payback amounts at a later time.

3. The system according to claim 2, wherein the one or more computers are further configured to raise funds from all the participants purchasing the debt instruments at a particular cost that is below market interest rate.

4. The system according to claim 1, wherein the accelerated payback scenario comprises a plurality of call events each of which selects the certain participants for the accelerated payback, and wherein the one or more computers are further configured to arrange for paybacks to the certain participants at each call event and to the other participants at a time after all the call events end.

5. The system according to claim 4, wherein each of the call events arranges for payback of higher amounts to certain participants selected in an earlier event compared to other participants or to participants selected in a later event, and wherein the number of selected participants in each event is the same.

6. The system according to claim 1, wherein the payback amounts for both the selected certain participants and for the other participants include coupon payments, wherein the coupon payments are paid to all participants until debt instrument matures.

7. The system according to claim 1, wherein the payback amounts for the participants include coupon payments only until the certain participants are selected.

8. A computer-based method for reducing cost to an issuer of a debt instrument, wherein all steps are conducted by a computer system, which method comprises:
establishing payback terms for participants in the debt investment, including a standard payback scenario for most participants and an accelerated payback scenario for certain participants;
establishing identifiable certificates evidencing portions of debt of the debt instrument;
selling the identifiable certificates to the participants at an investment amount;
selecting the certain participants for accelerated payback by randomly selecting some of the certificates according to pre-established criteria that at least include an earlier time of payment; and
arranging for payback of the investment amount for the certain participants at one time and for other participants at a later time.

9. The method of claim 8, wherein the one or more computers are configured to provide the selected certain participants with a higher payback amount compared to other participants who receive payback amounts at a later time.

10. The method of claim 8, wherein the one or more computers are further configured to raise funds from all the participants purchasing the debt instruments at a particular cost that is below market interest rate.

11. The method of claim 8, wherein the accelerated payback scenario comprises a plurality of call events each of which selects the certain participants for the accelerated payback, and wherein the one or more computers are further configured to arrange for paybacks to the certain participants at each call event and to the other participants at a time after all the call events end.

12. The method of claim 11, wherein each of the call events arranges for payback of higher amounts to certain participants selected in an earlier event compared to other participants or to participants selected in a later event, and wherein the number of selected participants in each event is the same.

13. The method of claim 8, wherein the payback amounts for both the selected certain participants and for the other participants include coupon payments, wherein the coupon payments are paid to all participants until debt instrument matures.

14. The method of claim 8, wherein the payback amounts for both the selected certain participants and for the other participants include coupon payments only until the certain participants are selected.

15. A non-transient computer-readable medium encoded with a computer program, the computer program comprising instructions that when executed by a computer system cause the computer system to perform the method of claim 8.
